(19) United States
(12) Patent Application Publication
(10) Pub. No.: US 2011/0319557 A1
(43) Pub. Date: Dec. 29, 2011

(54) Oil-In-Water Silicone Emulsion Composition

(76) Inventors: Kazuhiko Kojima, Ichihara-shi (JP); Tsutomu Naganawa, Ichihara-shi (JP); Masaru Ozaki, Ichihara-shi (JP)

(21) Appl. No.: 13/255,603

(22) PCT Filed: Mar. 5, 2010
(86) PCT No.: PCT/JP2010/054267

§ 371 Date: Sep. 9, 2011

(30) Foreign Application Priority Data
Mar. 10, 2009 (JP) JP2009-057084
Mar. 5, 2010 (JP) PCT/JP2010/054267

(51) Int. Cl. C09D 183/04

(52) U.S. Cl. 524/588

(57) ABSTRACT

An oil-in-water silicone emulsion composition comprising (A) 100 mass parts of a polyorganosiloxane that contains in each molecule at least two groups selected from the group consisting of the silicon-bonded hydroxyl group, silicon-bonded alkoxy groups, and silicon-bonded alkoxyalkoxy groups, (B) 0.1 to 200 mass parts of a colloidal silica, (C) 0.1 to 100 mass parts of an aminoxy group-containing organosilicon compound that contains at least three silicon-bonded aminoxy groups in each molecule, (D) 0.1 to 50 mass parts of a surfactant, and (E) 10 to 200 mass parts water. Such oil-in-water silicone emulsion composition that contains little low molecular weight silicone can form, even without the use of a tin catalyst, a cured film that exhibits a satisfactory strength and a satisfactory adherence to substrate, through the removal of the water fraction.

### TECHNICAL FIELD

The present invention relates to an oil-in-water silicone emulsion composition and more particularly relates to an oil-in-water silicone emulsion composition that contains colloidal silica. The present invention even more particularly relates to an oil-in-water silicone emulsion composition that contains colloidal silica and that, even without the use of a tin catalyst, is converted into a silicone elastomer through the removal of the water fraction and thereby forms a cured film that exhibits a satisfactory strength, i.e., a satisfactory rubbery elasticity, and a satisfactory adherence to substrate.

### BACKGROUND ART

Oil-in-water silicone emulsion compositions that through the removal of the water fraction form a water-repellent, stain-resistant, and heat-resistant cured film that exhibits mold releasability and peeling releasability are used in paints, paper coating agents, mold release agents, peeling release agents, fiber treatment agents, cosmetics, and so forth. There has been demand in recent years for an oil-in-water silicone emulsion composition that does not employ a tin catalyst as the curing catalyst, and this has led to the appearance of a composition comprising a hydroxyl-containing diorganosiloxane, a silicone resin, and an aminoxy group-terminated diorganosiloxane (refer to JP 06-073291 A) and a composition provided by the mixing and subsequent emulsification of a hydroxyl-containing diorganosiloxane and, as a crosslinking agent, a compound selected from linear siloxanes that have the aminoxy group in side chain position, cyclic aminoxysiloxanes, aminoxysilanes, and the partial hydrolysis products of the preceding (refer to JP 11-193349 A). However, these compositions have had the problems of an inadequate strength on the part of the cured film and/or an inadequate adherence to substrate by the cured film.

Oil-in-water silicone emulsion compositions that contain colloidal silica have been introduced in order to solve these problems (refer to JP 56-016553 A, JP 59-152972 A, JP 09-165554 A, and JP 10-168393 A).

However, the prior colloidal silica-containing oil-in-water silicone emulsion compositions have contained a polyorganosiloxane whose degree of polymerization has been increased by the emulsion polymerization during emulsion production of octamethylcyclotetrasiloxane and/or decamethylcyclopentasiloxane using a strong acid or strong base as the polymerization catalyst. A problem with these oil-in-water silicone emulsion compositions has been the presence of large amounts of siloxane oligomers, e.g., octamethylcyclotetrasiloxane, decamethylcyclopentasiloxane, and so forth, in the final product. This problem is due to the simultaneous occurrence of siloxane bond cleavage reactions during the emulsion polymerization with the production of new low molecular weight polyorganosiloxanes. Due to the volatility of siloxane oligomers such as octamethylcyclotetrasiloxane, decamethylcyclopentasiloxane, and so forth, these oil-in-water silicone emulsions have had the problem of not being usable depending on the particular application.

### PRIOR ART REFERENCES

### Patent References

Patent Reference 1: JP 06-073291 A
Patent Reference 2: JP 11-193349 A
Patent Reference 3: JP 56-016553 A
Patent Reference 4: JP 59-152972 A
Patent Reference 5: JP 09-165554 A
Patent Reference 6: JP 10-168393 A

### DISCLOSURE OF INVENTION

An object of the present invention is to provide an oil-in-water silicone emulsion composition that contains little volatile siloxane oligomer and that, through the removal of the water fraction and even without the use of a tin catalyst, is able to form a cured film that has a satisfactory strength, i.e., that has a satisfactory rubbery elasticity, and that exhibits a satisfactory adherence to substrate.

The oil-in-water silicone emulsion composition of the present invention characteristically comprises
(A) 100 mass parts of a polyorganosiloxane that contains in each molecule at least two groups selected from the group consisting of the silicon-bonded hydroxyl group, silicon-bonded alkoxy groups, and silicon-bonded alkoxyalkoxy groups,
(B) 0.1 to 200 mass parts of a colloidal silica,
(C) 0.1 to 100 mass parts of an aminoxy group-containing organosilicon compound that contains at least three silicon-bonded aminoxy groups in each molecule,
(D) 0.1 to 50 mass parts of a surfactant, and
(E) 10 to 200 mass parts water.

The total content of siloxane oligomers comprising 4 to 5 siloxane units in the oil-in-water silicone emulsion composition of the present invention is preferably not more than 2 mass %.

The aforementioned component (A) polyorganosiloxane is preferably a diorganopolysiloxane endblocked at both molecular chain terminals by the hydroxyl group and more preferably has a viscosity at 25° C. from 50 mPa·s to 2,000,000 mPa·s.

The aforementioned component (C) aminoxy group-containing organosilicon compound is preferably an aminoxy group-containing organosilicon compound represented by the general formula R²R¹₂SiO(R¹R³SiO)ₐ(R¹₂SiO)ₚSiR¹₂R² wherein R¹ is an unsubstituted monovalent hydrocarbyl group or a substituted monovalent hydrocarbyl group; R² is a group selected from monovalent hydrocarbyl groups, the hydroxyl group, alkoxy groups, alkoxyalkoxy groups, and aminoxy groups; R³ is an aminoxy group; n is an integer greater than or equal to 1; and p is an integer greater than or equal to 0.

The oil-in-water silicone emulsion composition of the present invention preferably additionally incorporates, as a component (F), 0.1 to 50 mass parts of an alkoxysilane or alkoxyalkoxysilane represented by R¹ₐSiX₄₋ₐ wherein R¹ is an unsubstituted monovalent hydrocarbyl group or a substituted monovalent hydrocarbyl group, X is an alkoxy group or an alkoxyalkoxy group, and a is 0, 1, or 2, or a partial hydrolysis and condensation product of the aforementioned alkoxysilane or alkoxyalkoxysilane. The oil-in-water silicone emulsion composition of the present invention also preferably additionally incorporates an amine as a component (G). The average particle size of the emulsion particles in the oil-in-water silicone emulsion composition of the present invention is preferably not more than 300 nm.

The method of producing the oil-in-water silicone emulsion composition of the present invention characteristically comprises the steps of: carrying out emulsification and dispersion on the aforementioned components (A), (C), and (D) and a portion of component (E); and incorporating component (B) and the remainder of component (E) in the emulsion provided by the preceding step.

The surface treatment method of the present invention is characterized by carrying out a surface treatment on the surface of a substrate with the oil-in-water silicone emulsion composition according to the present invention.

The oil-in-water silicone emulsion composition of the present invention can form a cured film through the removal of the water fraction and can do this without the use of a tin catalyst; moreover, the thusly formed cured film has a satisfactory strength, i.e., a satisfactory rubbery elasticity, and a satisfactory adherence to substrate. In addition, since a polyorganosiloxane that has in each molecule at least two silicon-bonded hydroxyl groups or hydrolyzable groups as herein specified is emulsified and dispersed, the content of siloxane oligomer, e.g., octamethylcyclotetrasiloxane, decamethylcyclopentasiloxane, and so forth, is low and use in a broad range of applications is thereby made possible. The method of the present invention for producing the oil-in-water silicone emulsion composition of the present invention can efficiently produce this oil-in-water silicone emulsion composition. The method of the present invention for treating a surface can efficiently form a cured silicone film that exhibits a satisfactory strength, i.e., a satisfactory rubbery elasticity, and a satisfactory adherence to substrate, on a wide variety of substrate surfaces.

### BEST MODE FOR CARRYING OUT THE INVENTION

Component (A) is a polyorganosiloxane that contains in each molecule at least two groups selected from the group consisting of the silicon-bonded hydroxyl group, silicon-bonded alkoxy groups, and silicon-bonded alkoxyalkoxy groups, and is the base component of the oil-in-water silicone emulsion composition of the present invention. The molecular structure of the component (A) polyorganosiloxane may be straight chain, cyclic, branched, dendritic, or network, but a straight chain or a partially branched straight chain is preferred. The groups selected from the group consisting of the hydroxyl group, alkoxy groups, and alkoxyalkoxy groups may be present in terminal position on the molecular chain or in side chain position on the molecular chain or in both positions. The alkoxy group is preferably a C₁₋₁₀ alkoxy group, e.g., methoxy, ethoxy, n-propoxy, isopropoxy, n-butoxy, t-butoxy, hexyloxy, cyclohexyloxy, octyloxy, decyloxy, and so forth, while the alkoxyalkoxy group is preferably a C₂₋₁₀ alkoxyalkoxy group, e.g., methoxymethoxy, methoxyethoxy, ethoxymethoxy, methoxypropoxy, and so forth.

Unsubstituted monovalent hydrocarbyl groups and substituted monovalent hydrocarbyl groups are examples of the silicon-bonded organic groups other than the groups selected from the group consisting of the hydroxyl group, alkoxy groups, and alkoxyalkoxy groups. C₁₋₁₀ unsubstituted monovalent hydrocarbyl groups are preferred for the unsubstituted monovalent hydrocarbyl groups from the standpoint of the emulsification-boosting action. The unsubstituted monovalent hydrocarbyl can be exemplified by C₁₋₁₀ alkyl such as methyl, ethyl, n-propyl, isopropyl, butyl, t-butyl, hexyl, octyl, decyl, and so forth; C₃₋₁₀ cycloalkyl such as cyclopentyl, cyclohexyl, and so forth; C₂₋₁₀ alkenyl such as vinyl, allyl, 5-hexenyl, 9-decenyl, and so forth; C₆₋₁₀ aryl such as phenyl, tolyl, xylyl, and so forth; and C₇₋₁₀ aralkyl such as benzyl, methylbenzyl, phenethyl, and so forth. Preferred thereamong are alkyl, alkenyl, and aryl, wherein methyl and phenyl are particularly preferred.

The substituted monovalent hydrocarbyl group can be exemplified by groups provided by replacing all or a portion of the hydrogen atoms in the aforementioned unsubstituted monovalent hydrocarbyl groups, and particularly in the C₁₋₁₀ alkyl and phenyl, with a halogen atom such as fluorine, chlorine, and so forth; an epoxy functional group such as glycidyloxy, epoxycyclohexyl, and so forth; a methacrylic functional group such as methacryloxy and so forth; an acrylic functional group such as acryloxy and so forth; an amino functional group such as the amino group, aminoethylamino, phenylamino, dibutylamino, and so forth; a sulfur-containing functional group such as the mercapto group, the tetrasulfide group, and so forth; or a substituent group such as alkoxy, hydroxycarbonyl, alkoxycarbonyl, and so forth.

The following are specific examples of the substituted monovalent hydrocarbyl group: 3,3,3-trifluoropropyl, perfluorobutylethyl, perfluorooctylethyl, 3-chloropropyl, 3-glycidoxypropyl, 2-(3,4-epoxycyclohexyl)ethyl, 5,6-epoxyhexyl, 9,10-epoxydecyl, 3-methacryloxypropyl, 3-acryloxypropyl, 11-methacryloxylundecyl, 3-aminopropyl, N-(2-aminoethyl)aminopropyl, 3-(N-phenylamino)propyl, 3-dibutylaminopropyl, 3-mercaptopropyl, 3-hydroxycarbonylpropyl, methoxypropyl, and ethoxypropyl.

The viscosity of component (A) at 25° C. is not particularly limited; however, taking into consideration the strength and adherence to substrate of the cured film provided by the oil-in-water silicone emulsion composition of the present invention, the handling characteristics during its production, and the particle size and stability during emulsification and dispersion, component (A) has a viscosity at 25° C. preferably of 50 mPa·s to 2,000,000 mPa·s, more preferably of 100 mPa·s to 500,000 mPa·s, and even more preferably of 500 mPa·s to 100,000 mPa·s.

Component (A) is preferably a diorganopolysiloxane that is endblocked at both molecular chain terminals by the hydroxyl group. Such a diorganopolysiloxane endblocked at both molecular chain terminals by the hydroxyl group can be exemplified by a polyorganosiloxane represented by the general formula HO(R¹₂SiO)ₘH.R¹ in this formula denotes the same silicon-bonded unsubstituted and substituted monovalent hydrocarbyl groups other than the hydroxyl or hydrolyzable groups as described above, wherein C₁₋₁₀ alkyl, C₆₋₁₀ aryl, and C₂₋₁₀ alkenyl are preferred and methyl and phenyl are particularly preferred. The subscript m is an integer with a value of at least 2 and preferably is a number that provides a viscosity at 25° C. from 50 mPa·s to 2,000,000 mPa·s.

The component (B) colloidal silica improves the strength of the cured film and improves the adherence of the cured film to substrate. Colloidal silica refers to silica particles that have been dispersed in water to provide a colloidal state; it has a silanol-rich surface and a particle size generally from about 1 nm to 1 μm. Colloidal silica can be exemplified by Snowtex 20, Snowtex 30, Snowtex 40, Snowtex C, Snowtex N, Snowtex O, Snowtex S, Snowtex 20L, Snowtex OL, Snowtex ST-XS, Snowtex ST-SS, Snowtex AK, and Snowtex BK from Nissan Chemical Industries, Ltd. These colloidal silicas are typically a 5 to 40 mass % dispersion in water. Component (B) is incorporated at preferably 0.1 to 200 mass parts and more preferably at 1 to 100 mass parts, in each case per 100 mass parts component (A).

The component (C) aminoxy group-containing organosilicon compound promotes the formation of a rubbery elastic cured film by bringing about the reaction and crosslinking of component (A) with itself and component (A) with component (B) in the oil-in-water silicone emulsion composition of the present invention. Component (C) contains at least three silicon-bonded aminoxy groups in each molecule, and the aminoxy groups may be present only in side chain position on the molecular chain or may be present in both terminal position on the molecular chain and in side chain position on the molecular chain. This aminoxy group-containing organosilicon compound can be exemplified by a polyorganoaminoxysiloxane endblocked at both molecular chain terminals by an aminoxy group, a diorganosiloxane.organoaminoxysiloxane copolymer endblocked at both molecular chain terminals by an aminoxy group, a polyorganoaminoxysiloxane endblocked at both molecular chain terminals by a triorganosilyl group, a diorganosiloxane.organoaminoxysiloxane copolymer endblocked at both molecular chain terminals by a triorganosilyl group, a cyclic polyorganoaminoxysiloxane, a cyclic diorganosiloxane.organoaminoxysiloxane copolymer, triaminoxyorganosilanes, and tetraminoxysilanes. Component (C) is incorporated at from 0.1 to 100 mass parts, preferably 0.5 to 50 mass parts, and more preferably 1 to 20 mass parts, in each case per 100 mass parts component (A).

Component (C) is preferably represented by the general formula

R²R¹₂SiO(R¹R³SiO)ₙ(R¹₂SiO)ₚSiR¹₂R².

R¹ in this formula is the same as previously described, among which C₁₋₁₀ alkyl, C₆₋₁₀ aryl, and C₂₋₁₀ alkenyl are preferred and methyl and phenyl are particularly preferred. R² is a group selected from the group consisting of C₁₋₁₀ unsubstituted monovalent hydrocarbyl groups, C₁₋₁₀ halogen-substituted monovalent hydrocarbyl groups, the hydroxyl group, C₁₋₁₀ alkoxy groups, C₂₋₁₀ alkoxyalkoxy groups, and aminoxy groups, and R³ is an aminoxy group. The unsubstituted monovalent hydrocarbyl can be exemplified by the same groups as provided above, among which C₁₋₁₀ alkyl, C₆₋₁₀ aryl, and C₂₋₁₀ alkenyl are preferred and methyl and phenyl are particularly preferred. The halogen-substituted monovalent hydrocarbyl groups can be exemplified by groups provided by substituting halogen for all or a portion of the hydrogen atoms in the aforementioned unsubstituted monovalent hydrocarbyl groups, wherein halogen-substituted alkyl is preferred, e.g., chloromethyl, 3,3,3-trifluoropropyl, 3,3,4,4,5,5,5-heptafluoropentyl, difluoromonochloropropyl, and so forth. The alkoxy and alkoxyalkoxy groups can be exemplified by the same groups as previously described. The aminoxy group can be exemplified by dimethylaminoxy, diethylaminoxy, dipropylaminoxy, diheptylaminoxy, and ethylmethylaminoxy, wherein the diethylaminoxy group is preferred.

In addition, n in the preceding formula is an integer with a value of at least 1, and, while the upper limit on n is not particularly limited, n is preferably an integer in the range from 1 to 2000 based on the ease of emulsification. When n is 1, R² in the preceding formula is an aminoxy group; when n is 2, at least one of the R² groups is an aminoxy group. p in the formula is an integer with a value of at least 0, and, while the upper limit on p is not particularly limited, p is preferably an integer in the range from 0 to 1000 based on the ease of emulsification. The aminoxy group-containing organosilicon compound under consideration can be exemplified by the aminoxy group-containing organosilicon compounds given by the following formulas. In these formulas, Me denotes the methyl group; Et denotes the ethyl group; and Pr denotes the propyl group.

### MeSi(ONEt₂)₃

### MeSi(ONPr₂)₄

### Si(ONEt₂)₄

### Me₃SiO(MeSi(ONEt₂)O)₅SiMe₃

### (ONEt₂)Me₂SiO(MeSi(ONEt₂)O)₅SiMe₂(ONEt₂)

### Me₃SiO(Me₂SiO)₄(MeSi(ONEt₂)O)₅SiMe₃

### Me₃SiO(Me₂SiO)₅(MeSi(ONEt₂)O)₃SiMe₃

### Me₃SiO(Me₂SiO)₃(MeSi(ONEt₂)O)₇SiMe₃

### (ONEt₂)Me₂SiO(Me₂SiO)₅(MeSi(ONEt₂)O)₃SiMe₂(ONEt₂)

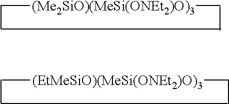

In addition, component (C) may be the partial hydrolysis and condensation product of an aminoxy group-containing organosilicon compound as described above.

The component (D) surfactant brings about a stable emulsification in component (E) of component (A) and the optionally incorporated component (F). A nonionic surfactant, anionic surfactant, cationic surfactant, or amphoteric surfactant can be used as the component (D) surfactant. A single type of surfactant may be used, or two or more surfactants of different type may be used in combination.

The nonionic surfactant can be exemplified by glycerol fatty acid esters, sorbitan fatty acid esters, polyoxyalkylene alkyl ethers, polyoxyalkylene alkylphenyl ethers, polyoxyalkylene sorbitan fatty acid esters, polyoxyalkylene glycerol fatty acid esters, and polyoxyethylene-polyoxypropylene copolymer-type nonionic emulsifying agents. The alkyl group referenced here can be exemplified by higher alkyl groups such as decyl, undecyl, dodecyl, tridecyl, tetradecyl, cetyl, stearyl, and so forth. The fatty acid can be exemplified by medium and higher fatty acids such lauric acid, palmitic acid, stearic acid, oleic acid, and so forth.

The anionic surfactant can be exemplified by alkylbenzenesulfonate salts, alkyl ether sulfate salts, polyoxyethylene alkyl ether sulfate salts, polyoxyethylene alkylphenyl ether sulfate salts, alkylnaphthylsulfonate salts, unsaturated aliphatic sulfonate salts, and hydroxylated aliphatic sulfonate salts. The alkyl group referenced here can be exemplified by medium and higher alkyl groups such as decyl, undecyl, dodecyl, tridecyl, tetradecyl, cetyl, stearyl, and so forth. The unsaturated aliphatic group can be exemplified by oleyl, nonenyl, and octynyl. The counterion can be exemplified by the sodium ion, potassium ion, lithium ion, and ammonium ion, with the sodium ion being typically used among these.

The cationic surfactant can be exemplified by quaternary ammonium salt-type surfactants such as alkyltrimethylammonium salts, e.g., octadecyltrimethylammonium chloride, hexadecyltrimethylammonium chloride, and so forth, and dialkyldimethylammonium salts, e.g., dioctadecyldimethylammonium chloride, dihexadecyldimethylammonium chloride, didecyldimethylammonium chloride, and so forth.

The amphoteric surfactant can be exemplified by alkylbetaines and alkylimidazolines.

The amount of component (D) incorporation is 0.1 to 50 mass parts and preferably 1 to 20 mass parts, in each case per 100 mass parts component (A).

The component (E) water preferably does not contain a component that interferes with emulsification or that impairs the storage stability of the emulsion, and can be exemplified by ion-exchanged water, distilled water, well water, and tap water. Component (E) is used in an amount sufficient for maintaining a stable water-based emulsion state, but the quantity of incorporation is not otherwise particularly limited. However, component (E) is ordinarily incorporated at from 10 to 200 mass parts per 100 mass parts component (A).

Viewed from the perspective of improving the strength and adherence of the cured film, the oil-in-water silicone emulsion of the present invention preferably also contains (F) an alkoxysilane or alkoxyalkoxysilane represented by R¹ₐSiX₄₋ₐ or a partial hydrolysis and condensation product of such an alkoxysilane or alkoxyalkoxysilane. R¹ in the formula is the same as previously described, among which C₁₋₁₀ alkyl, C₂₋₁₀ alkenyl, and C₆₋₁₀ aryl are preferred with methyl and phenyl being particularly preferred. X is preferably a C₁₋₁₀ alkoxy group or a C₂₋₁₀ alkoxyalkoxy group, and the same groups as previously described are examples here. a is 0, 1, or 2 and is preferably 0 or 1.

Specific examples of preferred alkoxysilanes are tetraalkoxysilanes such as tetraethoxysilane, tetrapropoxysilane, and so forth; alkyltrialkoxysilanes such as methyltrimethoxysilane, methyltriethoxysilane, methyltripropoxysilane, methyltributoxysilane, ethyltrimethoxysilane, ethyltriethoxysilane, ethyltripropoxysilane, ethyltributoxysilane, hexyltrimethoxysilane, octyltriethoxysilane, tetradecyltriethoxysilane, and so forth; substituted alkyltrialkoxysilanes as provided by replacing a portion of the hydrogen atoms on the alkyl in the preceding alkyltrialkoxysilanes with, for example, the methacryloxy group, glycidoxy group, amino group, and so forth; alkenyltrialkoxysilanes such as vinyltrimethoxysilane, vinyltriethoxysilane, and so forth; and aryltrialkoxysilanes such as phenyltrimethoxysilane, phenyltriethoxysilane, and so forth.

Specific examples of preferred alkoxyalkoxysilanes are tetraalkoxyalkoxysilanes such as tetramethoxymethoxysilane, tetraethoxyethoxysilane, tetramethoxyethoxysilane, tetraethoxymethoxysilane, and so forth; alkyltrialkoxyalkoxysilanes such as methyltrimethoxymethoxysilane, methyltriethoxyethoxysilane, methyltrimethoxyethoxysilane, methyltriethoxymethoxysilane, ethyltrimethoxymethoxysilane, ethyltriethoxyethoxysilane, ethyltrimethoxyethoxysilane, ethyltriethoxymethoxysilane, hexyltrimethoxyethoxysilane, octyltrimethoxyethoxysilane, tetradecyltrimethoxyethoxysilane, and so forth; substituted alkyltrialkoxyalkoxysilanes as provided by replacing a portion of the hydrogen atoms on the alkyl in the aforementioned alkyltrialkoxyalkoxysilanes with, for example, the methacryloxy group, glycidoxy group, amino group, and so forth; alkenyltrialkoxyalkoxysilanes such as vinyltrimethoxymethoxysilane, vinyltriethoxyethoxysilane, vinyltrimethoxyethoxysilane, vinyltriethoxymethoxysilane, and so forth; and aryltrialkoxyalkoxysilanes such as phenyltrimethoxymethoxysilane; phenyltriethoxyethoxysilane, phenyltrimethoxyethoxysilane, phenyltriethoxymethoxysilane, and so forth.

Tetraalkoxysilanes, alkyltrialkoxysilanes, tetraalkoxyalkoxysilanes, and alkyltrialkoxyalkoxysilanes are preferred among the preceding, while tetraalkoxysilanes and tetraalkoxyalkoxysilanes are more preferred.

Component (F) may also be a partial hydrolysis and condensation product from the aforementioned organoalkoxysilanes, organoalkoxyalkoxysilanes, tetraalkoxysilanes, or tetraalkoxyalkoxysilanes.

Component (F) is preferably incorporated at 0.1 to 50 mass parts and more preferably at 1 to 15 mass parts, in each case per 100 mass parts component (A). The improvement in the strength and adherence to substrate of the cured film from the resulting water-based emulsion may be inadequate when the quantity of component (F) incorporation is less than 0.1 mass part per 100 mass parts component (A). Exceeding 50 mass parts is disfavored because the higher amount of alcohol by-product has ill effects on the environment and human body and because the strength and adherence to substrate of the cured film may change with the passage of time.

In addition, the oil-in-water silicone emulsion composition of the present invention may incorporate other components on an optional basis as appropriate, for example, a thickener, antifoaming agent, penetrating agent, antistatic agent, inorganic powder, preservative, silane coupling agent, pH adjusting agent, buffer, ultraviolet absorber, tin-free curing catalyst, water-soluble resin, organic resin emulsion, pigment, dye, and so forth.

Among the preceding, the incorporation of an amine compound (G) as a pH adjusting agent is preferred. The amine compound can be exemplified by diethylamine, ethylenediamine, butylamine, hexylamine, morpholine, monoethanolamine, triethylamine, triethanolamine, dipropanolamine, and 2-amino-2-methyl-2-propanol, wherein diethylamine is preferred among the preceding. The quantity of incorporation of component (G) as the pH adjusting agent is preferably in the range from 0.01 to 5 mass % and is more preferably in the range from 0.1 to 2 mass %.

The oil-in-water silicone emulsion composition of the present invention can be produced by a production method comprising the steps of (I): carrying out emulsification and dispersion on components (A), (C), and (D) and a portion of component (E), using an emulsifying device such as, for example, a homomixer, homogenizer, colloid mill, Combi mixer, inline-type continuous emulsifying device, vacuum emulsifying device, ultrasound emulsifying device, continuous mixing apparatus, and so forth; and (II): incorporating and dispersing component (B) and the remainder of component (E) in the emulsion provided by the preceding step. Component (F) may optionally be incorporated in either step or may be subdivided and incorporated in each step. Viewed from the perspective of the stability upon dilution with water, the average particle size of the emulsion particles is preferably not more than 500 nm and is more preferably not more than 300 nm. The average particle size of the emulsion particles can be measured, for example, by a dynamic light scattering procedure.

The total content of siloxane oligomers comprising 4 to 5 siloxane units is preferably not more than 2 mass % in the oil-in-water silicone emulsion composition of the present invention and more preferably is not more than 1 mass % and even more preferably is not more than 0.5 mass %. The siloxane oligomers comprising 4 to 5 siloxane units can be exemplified by tetrameric to pentameric cyclic siloxane oligomers such as octaorganotetracyclosiloxane, decaorganopentacyclosiloxane, and so forth, and by tetrameric to pentameric straight-chain siloxane oligomers such as a tetraorganodisiloxane endblocked at both molecular chain terminals by a hydroxydiorganosiloxy group, a hexaorganotrisiloxane endblocked at both molecular chain terminals by a hydroxydiorganosiloxy group, and so forth. The siloxane oligomer content in the oil-in-water silicone emulsion composition of the present invention can be measured by gas chromatography.

The surface treatment method of the present invention characteristically comprises carrying out a surface treatment on the surface of a substrate with the oil-in-water silicone emulsion composition of the present invention. The substrate can be exemplified by metals, ceramics, concrete, paper, fibers, plastics, glass, and rubber.

The method of carrying out a surface treatment on the surface of a substrate with the aforementioned oil-in-water silicone emulsion composition preferably comprises (I) a step of coating the surface of the substrate with the oil-in-water silicone emulsion composition and (II) a step of removing the water in the oil-in-water silicone emulsion composition on the substrate surface to form a cured film on the substrate surface. The specific procedure for carrying out step (I) can be exemplified by spraying, dipping, gravure coating, knife coating, and so forth. The water removal in step (II) can be carried out by air drying by standing at ambient temperature; or by standing at an ambient temperature adjusted to 20 to 200° C.; or by exposure to infrared radiation, ultraviolet radiation, or other high energy radiation.

### EXAMPLES

The present invention is particularly described herebelow by examples and comparative examples. The viscosity in the examples is the value measured at 25° C.; the parts used to indicate the amount of incorporation denotes mass parts; and the % used to indicate content denotes mass %. In the formulas, Me refers to the methyl group and Et refers to the ethyl group.

The average particle size of the emulsion particles was measured by dynamic light scattering using a submicron particle analyzer (Coulter Model N4 MD from Coulter Electronics, Inc.) at 25° C. and was determined by monodispersion mode analysis.

The strength of the cured film and its adherence to a glass panel were evaluated by coating the emulsion composition on a glass panel; removing the water fraction by holding for one day at 25° C.; and then touching with a finger. With regard to the strength of the cured film, this was evaluated by touching with a finger to determine whether the cured film was adequately cured and exhibited rubbery elasticity. When elasticity was observed for the cured film, the film was also strongly rubbed with a finger to determine whether plastic deformation was seen. With regard to the adherence by the cured film to the glass panel, this was evaluated by rubbing the cured film strongly with a finger and checking whether peeling from the glass panel occurred.

The total content of siloxane oligomers comprising 4 to 5 siloxane units in the prepared oil-in-water silicone emulsion was measured by weighing out a 1.0 g sample; adding 5 mL methanol, 10 mL hexane, and 10 μL n-undecane and stirring for several minutes; thereafter holding at quiescence overnight and then adding 5 mL ultrapure water taking care to avoid disturbance; and subsequently recovering the hexane layer and performing the measurement with a gas chromatograph (GC-2010 from Shimadzu).

### Example 1

50.0 parts of a polydimethylsiloxane endblocked at both molecular chain terminals by the hydroxydimethylsiloxy group and having a viscosity of 2,400 mPa·s, 2.0 parts of the aminoxy group-containing polysiloxane given by formula (1) below, and 1.0 part tetraethoxysilane were mixed:

Me₃SiO(Me₂SiO)₁(MeSi(ONEt₂)O)₃SiMe₃ (1)

This was followed by the addition of 3.0 parts water and 8.0 parts of a 70% aqueous solution of sodium polyoxyethylene (2 mol) lauryl ether sulfate and mixing and then emulsification using a continuous mixing apparatus. After dilution with 1.5 parts water and 33.0 parts colloidal silica (trade name: Snowtex C, from Nissan Chemical Industries, Ltd., effective component=20%), 1.5 parts of an aqueous solution provided by diluting 0.5 part diethylamine as a pH adjusting agent with 1.0 part water was added, thus producing an oil-in-water silicone emulsion. The average particle size of the obtained emulsion particles was 320 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the status of the cured film was evaluated: a cured film having a satisfactory adherence and rubbery elasticity was obtained, while plastic deformation was not seen even upon forceful rubbing with a finger.

### Example 2

An emulsion was prepared as in Example 1, but in this case using 2.0 parts of the aminoxy group-containing polysiloxane given by formula (2) below rather than the 2.0 parts of the aminoxy group-containing polysiloxane given by formula (1) above and used in Example 1, and using 5.0 parts of an 85% aqueous solution of polyoxyethylene (7 mol) branched decyl ether as the emulsifying agent rather than the 8.0 parts 70% aqueous sodium polyoxyethylene (2 mol) lauryl ether sulfate solution.

Me₃SiO(Me₂SiO)₃(MeSi(ONEt₂)O)₅SiMe₃ (2)

The average particle size of the obtained emulsion particles was 360 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the status of the cured film was evaluated: a cured film having a satisfactory adherence and elasticity was obtained, but some plastic deformation was seen upon forceful rubbing with a finger. The obtained emulsion composition was also coated on a glass panel seven days after the preparation of the composition and the status of the cured film was evaluated: a cured film having a satisfactory adherence and rubbery elasticity was obtained, while plastic deformation was not seen even upon forceful rubbing with a finger.

### Example 3

An emulsion was prepared as in Example 1, but in this case using 2.0 parts of the aminoxy group-containing polysiloxane given by formula (2) above and used in Example 2 rather than the 2.0 parts of the aminoxy group-containing polysiloxane given by formula (1) above and used in Example 1, changing the water used for dilution from 1.5 parts to 18.0 parts, and changing the quantity of colloidal silica (trade name: Snowtex C, from Nissan Chemical Industries, Ltd., effective component=20%) from 33.0 parts to 16.5 parts. The average particle size of the obtained emulsion particles was 290 nm; the siloxane oligomers comprising 4 to 5 siloxane units were octamethyltetracyclosiloxane and decamethylpentacyclosiloxane; and their content was 0.12%. One day after its preparation, the obtained emulsion composition was coated on a glass panel and the status of the cured film was evaluated: a cured film having a satisfactory adherence and rubbery elasticity was obtained, while plastic deformation was not seen even upon forceful rubbing with a finger.

### Example 4

An emulsion was prepared as in Example 3, but in this case changing the tetraethoxysilane used in Example 3 to methyltriethoxysilane. The average particle size of the obtained emulsion particles was 320 nm; the siloxane oligomers comprising 4 to 5 siloxane units were octamethyltetracyclosiloxane and decamethylpentacyclosiloxane; and their content was 0.12%. One day after its preparation, the obtained emulsion composition was coated on a glass panel and the status of the cured film was evaluated: a cured film having a satisfactory adherence and rubbery elasticity was obtained, while plastic deformation was not seen even upon forceful rubbing with a finger.

### Example 5

50.0 parts polydimethylsiloxane endblocked at both molecular chain terminals by the hydroxydimethylsiloxy group and having a viscosity of 2,400 mPa·s, 1.0 part aminoxy group-containing polysiloxane given by formula (2) above, and 1.0 part tetraethoxysilane were mixed. This was followed by the addition of 8.0 parts of a 70% aqueous solution of sodium polyoxyethylene (2 mol) lauryl ether sulfate, 1.0 part polyoxyethylene-polyoxypropylene copolymer-type nonionic emulsifying agent (product name: Pluronic F68, from Adeka Corporation), and 3.0 parts water and mixing and then emulsification using a continuous mixing apparatus. After dilution with 18.0 parts water and 16.5 parts colloidal silica (trade name: Snowtex C, from Nissan Chemical Industries, Ltd., effective component=20%), 1.5 parts of an aqueous solution provided by diluting 0.5 part diethylamine as a pH adjusting agent with 1.0 part water was added, thus producing an oil-in-water silicone emulsion. The average particle size of the obtained emulsion particles was 190 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the status of the cured film was evaluated: a cured film having a satisfactory adherence and rubbery elasticity was obtained, while plastic deformation was not seen even upon forceful rubbing with a finger.

### Example 6

An emulsion was prepared as in Example 5, but in this case using methyltriethoxysilane in place of the tetraethoxysilane used in Example 5. The average particle size of the obtained emulsion particles was 220 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the status of the cured film was evaluated: a cured film having a satisfactory adherence and rubbery elasticity was obtained, while plastic deformation was not seen even upon forceful rubbing with a finger.

### Example 7

An emulsion was prepared as in Example 2, but in this case without incorporating the tetraethoxysilane that was used in Example 2. The average particle size of the obtained emulsion particles was 275 nm; the siloxane oligomers comprising 4 to 5 siloxane units were octamethyltetracyclosiloxane, and decamethylpentacyclosiloxane; and their content was 0.12%. Seven days after its preparation, the obtained emulsion composition was coated on a glass panel and the status of the cured film was evaluated: a cured film having a satisfactory adherence and elasticity was obtained; however, a slight plastic deformation was seen upon forceful rubbing with a finger.

### Comparative Example 1

An emulsion was prepared as in Example 1, but in this case using 2.0 parts of the aminoxy group-containing polysiloxane given by the following formula (3) in place of the 2.0 parts aminoxy group-containing polysiloxane given by formula (1) and used in Example 1.

Et₂NO(Me₂SiO)₇NEt₂ (3)

The particle size in the obtained emulsion was 270 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the water fraction was removed; however, only a very weak film that was strongly tacky and lacking elasticity was obtained. The obtained emulsion composition was also coated twenty days after its preparation on a glass panel and the water fraction was removed: in this case the obtained film was a weak film that exhibited tack and that lacked elasticity.

### Comparative Example 2

50.0 parts of a polydimethylsiloxane endblocked at both molecular chain terminals by the hydroxydimethylsiloxy group and having a viscosity of 4,000 mPa·s, 6.0 parts of a 70% aqueous solution of sodium polyoxyethylene (2 mol) lauryl ether sulfate, and 3.0 parts water were mixed and emulsification was then carried out using a continuous mixing apparatus. After dilution with 19.5 parts water and 19.5 parts colloidal silica (trade name: Snowtex C, from Nissan Chemical Industries, Ltd., effective component=20%), 1.5 parts of an aqueous solution provided by diluting 0.5 part diethylamine as a pH adjusting agent with 1.0 part water was added, thus producing an oil-in-water silicone emulsion. The average particle size of the obtained emulsion particles was 370 nm; the siloxane oligomers comprising 4 to 5 siloxane units were octamethyltetracyclosiloxane and decamethylpentacyclosiloxane; and their content was 0.25%. Nine days after its preparation, the obtained emulsion was coated on a glass panel and the water fraction was removed; however, the obtained film was a very weak film that was strongly tacky and that lacked elasticity.

### Comparative Example 3

An emulsion was prepared as in Comparative Example 2, but in this case carrying out emulsification using 8.0 parts of the 70% aqueous solution of sodium polyoxyethylene (2 mol) lauryl ether sulfate used in Comparative Example 2 rather than 6.0 parts; changing the amount of dilution water from 19.5 parts to 4.5 parts; and changing the amount of colloidal silica from 19.5 parts to 33.0 parts. The average particle size of the obtained emulsion particles was 280 nm; the siloxane oligomers comprising 4 to 5 siloxane units were octamethyltetracyclosiloxane and decamethylpentacyclosiloxane; and their content was 0.25%. Seven days after its preparation, the obtained emulsion composition was coated on a glass panel and the water fraction was removed; however, the obtained film was a very weak film that was strongly tacky and that lacked elasticity. When the obtained emulsion composition was also coated twenty days after its preparation on a glass panel and the water fraction was removed, a film was obtained that had a relatively good adherence; however, numerous cracks were seen in the surface of the cured film and the elasticity of the film was also poor.

### Comparative Example 4

An emulsion was prepared by the same procedure as in Example 2, but in this case changing the 1.0 part tetraethoxysilane of Example 2 to 1.0 part methyltriethoxysilane and changing the 33.0 parts colloidal silica to 33.0 parts water. The average particle size of the obtained emulsion particles was 290 nm; the siloxane oligomers comprising 4 to 5 siloxane units were octamethyltetracyclosiloxane and decamethylpentacyclosiloxane; and their content was 0.12%. Three days after its preparation, the obtained emulsion composition was coated on a glass panel and the water fraction was removed: a cured film was obtained that exhibited elasticity, but the cured film exhibited an inadequate adherence and was easily peeled from the glass panel by finger pressure. The same evaluation was performed ten days after the preparation of the emulsion composition, but an improvement in the adherence of the cured film was not seen.

### INDUSTRIAL APPLICABILITY

The oil-in-water silicone emulsion composition of the present invention, when coated on or impregnated in a substrate followed by removal of the water fraction, forms a cured film that exhibits an excellent adherence to the substrate and that has rubbery elasticity, i.e., an excellent strength. Because of this, the oil-in-water silicone emulsion composition of the present invention is useful for, for example, water-based paints and inks; paper coating agents for use with thermal paper, inkjet paper, and so forth; mold release agents for molds, dies, and rubber; resin coating agents for use on automotive weather stripping, gaskets, rubber hoses, and so forth; fiber treatment agents for use with clothing and air bags; peeling release agents; cosmetics; and so forth.

1. An oil-in-water silicone emulsion composition comprising
(A) 100 mass parts of a polyorganosiloxane that contains in each molecule at least two groups selected from the group of a silicon-bonded hydroxyl group, silicon-bonded alkoxy groups, and silicon-bonded alkoxyalkoxy groups,
(B) 0.1 to 200 mass parts of a colloidal silica,
(C) 0.1 to 100 mass parts of an aminoxy group-containing organosilicon compound that contains at least three silicon-bonded aminoxy groups in each molecule,
(D) 0.1 to 50 mass parts of a surfactant, and
(E) 10 to 200 mass parts water.

2. The oil-in-water silicone emulsion composition according to claim 1, wherein the total content of siloxane oligomers comprising 4 to 5 siloxane units is not more than 2 mass %.

3. The oil-in-water silicone emulsion composition according to claim 1, wherein the component (A) polyorganosiloxane is a diorganopolysiloxane endblocked at both molecular chain terminals by a hydroxyl group.

4. The oil-in-water silicone emulsion composition according to claim 3, wherein the viscosity of component (A) at 25° C. is from 50 mPa·s to 2,000,000 mPa·s.

5. The oil-in-water silicone emulsion composition according to claim 1, wherein the component (C) aminoxy group-containing organosilicon compound is an aminoxy group-containing organosilicon compound represented by the general formula R²R¹₂SiO(R¹R³SiO)ₙ(R¹₂SiO)ₚSiR¹₂R² wherein R¹ is an unsubstituted monovalent hydrocarbyl group or a substituted monovalent hydrocarbyl group; R² is a group selected from monovalent hydrocarbyl groups, a hydroxyl group, alkoxy groups, alkoxyalkoxy groups, and aminoxy groups; R³ is an aminoxy group; n is an integer greater than or equal to 1; and p is an integer greater than or equal to 0.

6. The oil-in-water silicone emulsion composition according to claim 1, further comprising, as a component (F), 0.1 to 50 mass parts of an alkoxysilane or alkoxyalkoxysilane represented by R¹ₐSiX₄₋ₐ wherein R¹ is an unsubstituted monovalent hydrocarbyl group or a substituted monovalent hydrocarbyl group, X is an alkoxy group or an alkoxyalkoxy group, and a is 0, 1, or 2, or a partial hydrolysis and condensation product of the alkoxysilane or alkoxyalkoxysilane.

7. The oil-in-water silicone emulsion composition according to claim 1, further comprising an amine as a component (G).

8. The oil-in-water silicone emulsion composition according to claim 1, wherein the average particle size of the emulsion particles is not more than 300 nm.

9. A method of producing the oil-in-water silicone emulsion composition according to claim 1, the method comprising the steps of:
carrying out emulsification and dispersion on the (A) polyorganosiloxane that contains in each molecule at least two groups selected from the group of the silicon-bonded hydroxyl group, the silicon-bonded alkoxy groups, and the silicon-bonded alkoxyalkoxy groups, the (C) aminoxy group-containing organosilicon compound that contains at least three silicon-bonded aminoxy groups in each molecule, the (D) surfactant, and a portion of the (E) water; and
incorporating the (B) colloidal silica and the remainder of the (E) water in the emulsion provided by the preceding step.

10. A method of treating a surface of a substrate, the method comprising carrying out a surface treatment on the surface of the substrate with the oil-in-water silicone emulsion composition according to claim 1.

11. The oil-in-water silicone emulsion composition according to claim 2, wherein the component (A) polyorganosiloxane is a diorganopolysiloxane endblocked at both molecular chain terminals by the hydroxyl group.

12. The oil-in-water silicone emulsion composition according to claim 11, wherein the viscosity of component (A) at 25° C. is from 50 mPa·s to 2,000,000 mPa·s.
